(19) United States
(12) Patent Application Publication
(10) Pub. No.: US 2026/0079844 A1
(43) Pub. Date: Mar. 19, 2026

(54) DATA PROCESSING DEVICE, MAGNETIC RECORDING DEVICE, METHOD FOR MANUFACTURING MAGNETIC RECORDING DEVICE, AND DATA PROCESSING METHOD

(71) Applicant: KABUSHIKI KAISHA TOSHIBA, Tokyo (JP)

(72) Inventors: Katsuya SUGAWARA, Kawasaki Kanagawa (JP); Yousuke ISOWAKI, Yokohama Kanagawa (JP); Kenichiro YAMADA, Minato Tokyo (JP)

(21) Appl. No.: 19/233,946

(22) Filed: Jun. 10, 2025

(30) Foreign Application Priority Data
Sep. 18, 2024 (JP) 2024-160997

(51) Int. Cl. G06F 12/0842; G06F 9/34; G06N 20/00

(52) U.S. Cl. CPC G06F 12/0842; G06F 9/34; G06N 20/00

(57) ABSTRACT

According to one embodiment, a data processing device includes an acquisitor and a processor. The acquisitor is configured to acquire a plurality of second data corresponding to at least a part of waveform data including a first data. the processor is configured to perform a first operation and a second operation. The processor is configured to correct a first processing so that a difference between the first data and fourth data obtained by interpolating a plurality of third data obtained by processing the plurality of second data by the first processing decreases in the first operation. The processor is configured to process a plurality of fifth data by the first processing after the correcting to derive a plurality of sixth data in the second operation.

### CROSS-REFERENCE TO RELATED APPLICATIONS

This application is based upon and claims the benefit of priority from Japanese Patent Application No. 2024-160997, filed on Sep. 18, 2024; the entire contents of which are incorporated herein by reference.

### FIELD

Embodiments described herein relate generally to a data processing device, a magnetic recording device, a method for manufacturing a magnetic recording device, and a data processing method.

### BACKGROUND

For example, data for controlling a magnetic recording device or the like is processed by a data processing device. Improvement in efficiency in data processing is desired.

### BRIEF DESCRIPTION OF THE DRAWINGS

FIG. 1 is a schematic diagram illustrating a data processing device according to a first embodiment;

FIGS. 2A and 2B are schematic diagrams illustrating the operation of the data processing device;

FIGS. 3A and 3B are schematic diagrams illustrating the operation of the data processing device;

FIG. 4 is a graph illustrating the characteristics of the data processing device; and

FIG. 5 is a schematic diagram illustrating a data processing device according to the first embodiment.

### DETAILED DESCRIPTION

According to one embodiment, a data processing device includes an acquisitor and a processor. The acquisitor is configured to acquire a plurality of second data corresponding to at least a part of waveform data including a first data. the processor is configured to perform a first operation and a second operation. The processor is configured to correct a first processing so that a difference between the first data and fourth data obtained by interpolating a plurality of third data obtained by processing the plurality of second data by the first processing decreases in the first operation. The processor is configured to process a plurality of fifth data by the first processing after the correcting to derive a plurality of sixth data in the second operation.

Various embodiments are described below with reference to the accompanying drawings. In the specification and drawings, components similar to those described previously or illustrated in an antecedent drawing are marked with like reference numerals, and a detailed description is omitted as appropriate.

### First Embodiment

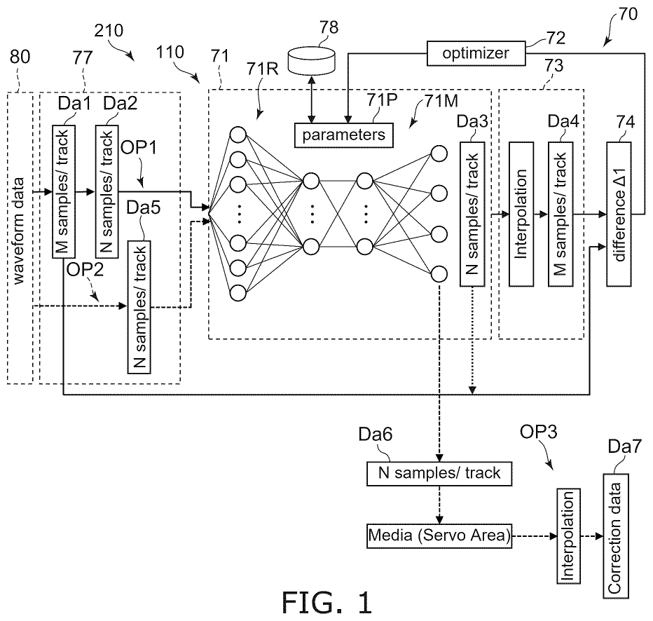

FIG. 1 is a schematic diagram illustrating a data processing device according to a first embodiment.

As shown in FIG. 1, a data processing device 110 according to the embodiment includes an acquisitor 77 and a processor 70.

The acquisitor 77 is configured to acquire a plurality of data. The plurality of data is, for example, at least a part of waveform data. The waveform data may be, for example, periodic data. The waveform data may include, for example, control data related to a magnetic recording medium 80. The waveform data may include, for example, information related to RRO (Repeatable Run Out) of the magnetic recording medium 80. Below, an example will be described in which the data processing device 110 processes data related to the magnetic recording medium 80.

The waveform data includes, for example, a first data Da1. The first data Da1 may include information related to RRO.

The acquisitor 77 is configured to acquire a plurality of second data Da2. The second data Da2 corresponds to at least a part of the waveform data including the first data Da1. In a case where the first data Da1 relates to RRO, the plurality of second data Da2 may be sampled RRO.

For example, the first data Da1 may have “M” samplings per track of the magnetic recording medium 80. “M” may be 2 or more. The plurality of second data Da2 may have “N” samplings per track of the magnetic recording medium 80. “N” may be 2 or more and “M”or less. In one example, “M”is 32 and “N”is 4.

For example, in a case of trying to obtain RRO data for one magnetic recording medium 80, it would take a long time to obtain the data if data are obtained from all positions in the track. For this reason, it is possible to obtain data regarding RRO by sampling based on “N”, which is smaller than “M”. This allows data to be obtained in a short amount of time, making it possible to obtain data efficiently.

In the embodiment, the processor 70 is configured to perform the following first operation OP1 and second operation OP2 (see FIG. 1). In the first operation OP1, the processor 70 processes the plurality of second data Da2 using a first processing 71R to obtain a plurality of third data Da3. The processor 70 interpolates the plurality of third data Da3 obtained by the first processing 71R to obtain a fourth data Da4. The first processing 71R is corrected so that a difference Δ1 between the fourth data Da4 being obtained and the first data Da1 decreases.

In the second operation OP2, the processor 70 is configured to process a plurality of fifth data Da5 by the first processing 71R being corrected to derive a plurality of sixth data Da6. The data obtained by interpolating the plurality of sixth data Da6 becomes data closer to the first data Da1. Highly accurate data processing can be performed efficiently.

The first processing 71R may include, for example, processing the plurality of the second data Da2 using a learning model 71M including learning parameters 71P. The first processing 71R may include, for example, processing using a neural network (NN).

As shown in FIG. 1, for example, the processor 70 may include a first processor 71. The first processor 71 is configured to perform a first processing 71R. The first processor 71 is configured to process the plurality of second data Da2 using the learning model 71M including the learning parameters 71P. Machine learning is performed in the first processor 71.

As shown in FIG. 1, the processor 70 may include a second processor 72. The second processor 72 is configured to modify the learning parameters 71P so that the above difference Δ1 (the difference between the fourth data Da4 and the first data Da1) decreases. The learning model 71M is obtained that includes the learning parameters 71P modified to reduce the difference Δ1. Such a learning model 71M corresponds to a trained model. The data processing according to the embodiment corresponds to a process of generating a trained model.

As shown in FIG. 1, the processor 70 may include a third processor 73. The third processor 73 is configured to derive the fourth data Da4 by interpolating the plurality of third data Da3. In the third processor 73, for example, linear interpolation may be performed. In the third processor 73, for example, second-order or higher-order interpolation may be performed. In the third processor 73, for example, interpolation using a differentiable function may be performed.

As shown in FIG. 1, the processor 70 may include a fourth processor 74. The fourth processor 74 is configured to derive the difference Δ1 between the fourth data Da4 and the first data Da1. At least a part of the learning parameters 71P is modified so that the difference Δ1 derived by the fourth processor 74 decreases. As a result, data closer to the first data Da1 is obtained based on the plurality of second data Da2 having a smaller number of data.

As already explained, the first data Da1 may include periodic data. The plurality of second data Da2 may include periodic data.

For example, the plurality of second data Da2 may include information regarding the RRO of the magnetic recording medium 80. The plurality of fifth data Da5 may include information regarding the RRO of the magnetic recording medium 80. The plurality of sixth data Da6 obtained by the second operation OP2 may be recorded in a servo region of the magnetic recording medium 80 (see FIG. 1).

As shown in FIG. 1, the data processing device 110 may include a memory 78. The memory 78 is configured to store the learning parameters 71P. For example, the learning parameters 71P being modified may be stored in the memory 78. The learning parameters 71P stored in the memory 78 may be read out. In the second operation OP2, the first processing 71R may be performed based on the learning parameters 71P being read out.

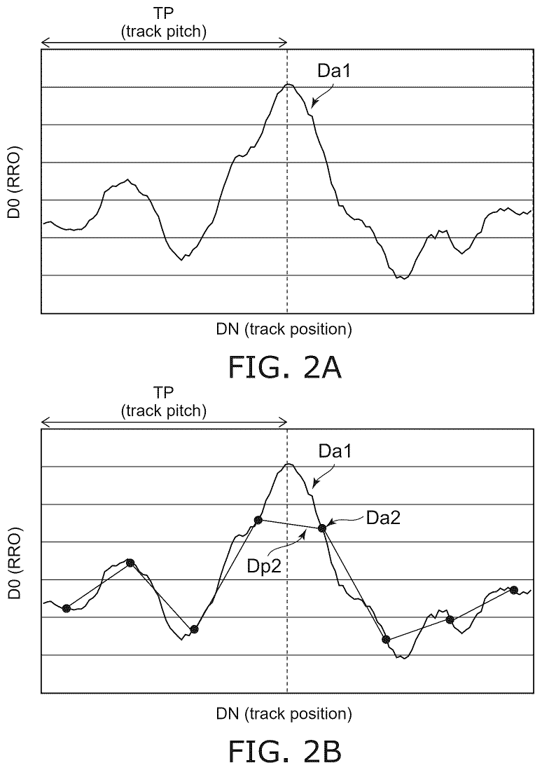

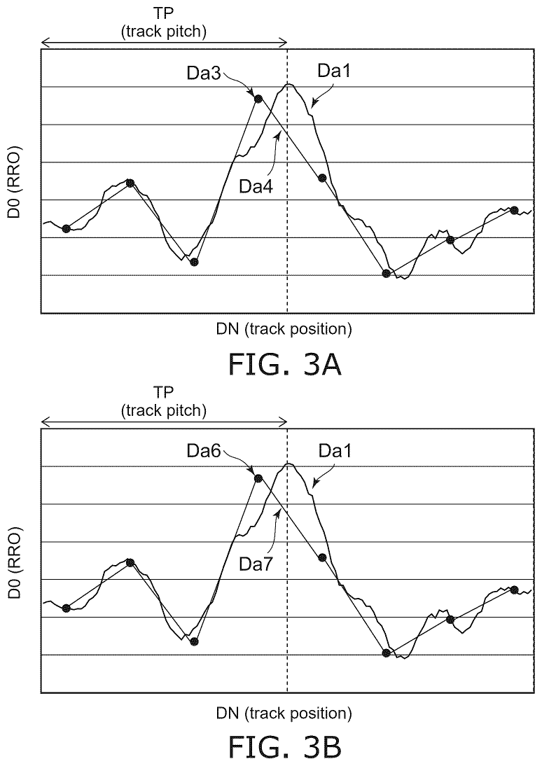

FIGS. 2A, 2B, 3A and 3B are schematic diagrams illustrating the operation of the data processing device.

The horizontal axis in these diagrams is data number DN. In a case where the target data is data relating to RRO of the magnetic recording medium 80, the data number DN corresponds to the position in the cross-track direction of the magnetic recording medium 80. The vertical axis is data D0. The data D0 is, for example, the RRO.

The first data Da1 changes periodically. For example, the period TP corresponds to one track. In the example of FIG. 2A, in one track, the first data Da1 includes 32 values. For example, “M” is 32. In FIG. 2A, to make the figured easier to see, the marks of the 32 pieces of data included in one track (one of the plurality of periods TP) have been omitted.

As shown in FIG. 2B, in this example, the number of the plurality of second data Da2 acquired by the acquisitor 77 is smaller than the number of values included in the first data Da1. In this example, in one track, the plurality of second data Da2 include four values. For example, “N” is 4. For example, each of the plurality of values (plurality of circles) included in the plurality of second data Da2 overlaps the first data Da1.

The interpolated data Dp2 is obtained by linearly interpolating the plurality of second data Da2. The interpolated data Dp2 represents the first data Da1 to some extent. However, the difference between the interpolated data Dp2 and the first data Da1 is not necessarily small. The interpolated data Dp2 corresponds to, for example, a reference example.

By processing such plurality of second data Da2 using the learning model 71M, the plurality of third data Da3 (see FIG. 3A) can be derived.

The plurality of third data Da3 shown in FIG. 3A are obtained from the plurality of second data Da2 illustrated in FIG. 2B. In one track, the plurality of third data Da3 include four values. The plurality of values (plurality of circles) included in the plurality of third data Da3 may be shifted from the curve of the first data Da1.

By interpolating the plurality of such third data Da3, the fourth data Da4 (see FIG. 3A) is obtained. For example, linear interpolation may be performed. For example, second-order or higher-order interpolation may be performed.

As already explained, for example, the difference Δ1 between the fourth data Da4 obtained by the interpolation and the first data Da1 is derived. Then, the learning parameters 71P are modified so that the difference Δ1 decreases. For example, the learning parameters 71P are modified so that the sum of the squares of the differences between the fourth data Da4 and the first data Da1 becomes minimum.

As shown in FIG. 3B, in the second operation OP2, another data (the plurality of fifth data Da5) is processed by the learning model 71M including the learning parameters 71P being modified. At least a part of the plurality of fifth data Da5 may be shifted from the plurality of third data Da3.

The fifth data Da5 is processed using the learning parameters 71P being modified to obtain the plurality of sixth data Da6 (see FIG. 3B). A seventh data Da7 (see FIG. 3B) is derived by interpolating the plurality of sixth data Da6. The difference between the seventh data Da7 and the first data Da1 is smaller than, for example, the difference between the interpolated data Dp2 illustrated in FIG. 2B and the first data Da1 (the difference in the reference example). A highly accurate RRO can be efficiently derived from a small number of the plurality of fifth data Da5.

In this way, the processor 70 corrects the first processing 71R in the first operation OP1. In the second operation OP2, the processor 70 processes other data (plurality of fifth data Da5) using the first processing 71R being corrected to derive the plurality of sixth data Da6. The processor 70 may further derive the seventh data Da7 by interpolating the plurality of sixth data Da6. The first data Da1, which has a large number of data, is represented with high accuracy by the seventh data Da7, which has a small number of data.

In the embodiment, the number (second number) of the plurality of second data Da2 may be the same as the number (third number) of the plurality of third data Da3. In the above example, the number of these per track is “N”. In the embodiment, a more accurate data processing result is obtained by processing using the learning model 71M based on the learning parameters 71P being corrected. A more accurate RRO is obtained.

In the embodiment, the number (second number) of the plurality of second data Da2 may be smaller than the number (third number) of the plurality of third data Da3. For example, in a case where the first data Da1 includes 32 values per track, the plurality of third data Da3 may include 4 values per track. In this case, the plurality of second data Da2 may include 3.7 values per track. For example, in a case where the plurality of third data Da3 includes “N1” values per track, the plurality of second data Da2 may include 0.925 times “N1” values per track. In the embodiment, the plurality of third data Da3 with high accuracy can be obtained from a small number of plurality of second data Da2 by processing using the learning model 71M based on the learning parameters 71P being corrected. For example, the actual measurement time for RRO can be shortened. Efficient data acquisition becomes possible.

In the embodiment, the second number of the plurality of second data Da2 may be the same as the fifth number of the plurality of fifth data Da5.

In the embodiment, the interpolation function that generates the fourth data Da4 from the plurality of third data Da3 may be a differentiable function. By applying a differentiable function, for example, an error function generated from the difference Δ1 between the fourth data Da4 and the first data Da1 can be back-propagated to the learning model 71M. The learning parameters 71P can be appropriately corrected.

As shown in FIG. 1, a third operation OP3 may further be performed. In the third operation OP3, the seventh data Da7 is derived by interpolating the plurality of sixth data Da6. In one example, the control device that performs the third operation OP3 may be different from the processor 70 described above. An eighth data Da8 is used, for example, to correct tracking in the magnetic recording device 210.

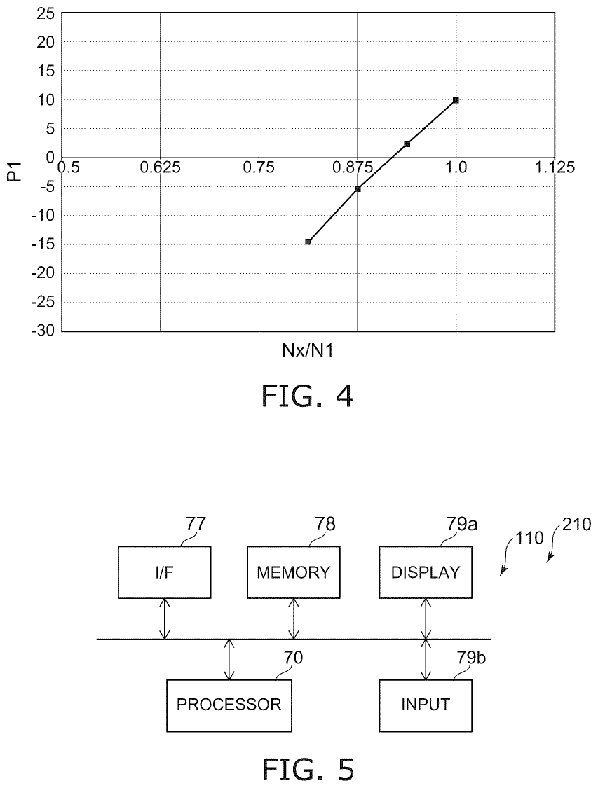

FIG. 4 is a graph illustrating the characteristics of the data processing device.

FIG. 4 illustrates the characteristics of the difference between the sixth data Da6 and a value obtained by linearly interpolating the plurality of second data Da2. The horizontal axis is the number Nx of the plurality of second data Da2. The number Nx corresponds to the number of values included in one track. In this example, the horizontal axis is normalized by “N1”. The vertical axis is an accuracy parameter P1. The accuracy parameter P1 corresponds to 3σ (three times the standard deviation) of the difference between the sixth data Da6 and a value actually measured with the number “M”. In the example of FIG. 4, the accuracy parameter P1 is based on the value of 3σ when Nx/N1 is 1. When the accuracy parameter P1 is positive and large, a higher accuracy than the standard is obtained. When the accuracy parameter P1 is negative, the accuracy is lower than the standard.

As shown in FIG. 4, when the number N1 is 4, the accuracy parameter P1 has a large positive value. By performing interpolation using the learning parameters 71P that has been corrected so that the difference Δ1 is small, highly accurate interpolated data can be obtained.

As shown in FIG. 4, in a case where Nx/N1 is greater than 0.925, an accuracy parameter P1 greater than 0 is obtained. For example, a number of data per track that is 0.925 times or more the number N1 can provide accuracy equal to or greater than that obtained from N1 pieces of data per track. For example, the number of the plurality of second data Da2 to be measured can be reduced from N1 pieces per track to 0.925 times N1 per track. Highly efficient data acquisition becomes possible.

In the data processing device 110 according to the embodiment, for example, a small-scale neural network (e.g., first processor 71) is provided before linear interpolation. The first processor 71 can improve the accuracy of data interpolation. For example, learning is performed by the NN using the difference Δ1 after interpolation as the loss function. This makes it possible to realize a NN that can improve accuracy after interpolation with small-scale calculations. The interpolation may be, for example, linear interpolation.

For example, high interpolation accuracy can be obtained with small-scale calculations. The data processing device 110 according to the embodiment can be applied to, for example, RRO. The data processing device 110 according to the embodiment can be applied to processing data obtained from, for example, various memories or sensors.

FIG. 5 is a schematic diagram illustrating a data processing device according to the first embodiment.

The data processing device 110 includes the acquisitor 77. The acquisitor 77 is capable of acquiring, for example, various types of data. The acquisitor 77 includes, for example, an I/O port. The acquisitor 77 is an interface. The acquisitor 77 may have the function of an output device. The acquisitor 77 may have, for example, a communication function.

In this example, the data processing device 110 includes the memory 78. The memory 78 is capable of storing various data. The memory 78 may include at least one of a ROM (Read Only Memory) and a DAM (Random Access Memory).

The data processing device 110 may include a display 79a and an input device 79b. The display 79a may include various displays. The input device 79b may include, for example, a device with an operation function (such as a keyboard, a mouse, a touch-type input panel, or a voice recognition input device).

The processor 70 may include, for example, a CPU (Central Processor). The processor 70 may include, for example, an electronic circuit.

The plurality of elements included in the data processing device 110 can communicate with each other by at least one of wireless or wired methods. The plurality of elements included in the data processing device 110 may be provided in different locations. A dedicated circuit may be used as at least a part of the data processing device 110 (e.g., the processor 70, etc.). For example, plurality of circuits connected to each other may be used as the data processing device 110.

For example, a general-purpose computer may be used as the data processing device 110. For example, plurality of computers connected to each other may be used as the data processing device 110.

### Second Embodiment

The second embodiment relates to a magnetic recording device. As shown in FIG. 1, a magnetic recording device 210 according to the embodiment includes the data processing device 110 according to the first embodiment and the magnetic recording medium 80. The acquisitor 77 is configured to acquire the plurality of second data Da2 from the magnetic recording medium 80.

The plurality of sixth data Da6 described in relation to the first embodiment may be recorded on the magnetic recording medium 80. For example, the plurality of sixth data Da6 may be recorded in a servo area provided on the magnetic recording medium 80. The plurality of sixth data Da6 may correspond to, for example, corrected RRO data.

### Third Embodiment

The third embodiment relates to a method for manufacturing a magnetic recording device 210. This manufacturing method includes obtaining the plurality of second data Da2 corresponding to at least a part of waveform data including first data Da1 from the magnetic recording medium 80. This manufacturing method includes performing the first operation OP1 and the second operation OP2.

The first operation OP1 includes correcting the first processing 71R so that the difference Δ1 between the first data Da1 and the fourth data Da4 obtained by interpolating the plurality of third data Da3 obtained by processing the plurality of second data Da2 using the first processing 71R decreases. The second operation OP2 includes processing the fifth data Da5 using the first processing 71R being corrected to derive the sixth data Da6.

The first processing 71R may include processing the plurality of second data Da2 using the learning model 71M including the learning parameters 71P. The manufacturing method may include modifying the learning parameters 71P so that the difference Δ1 decreases.

The plurality of second data Da2 may include information regarding repeatable run out (RRO) related to the magnetic recording medium 80. The manufacturing method may include recording the plurality of sixth data Da6 on the magnetic recording medium 80.

### Fourth Embodiment

The fourth embodiment relates to a data processing method. The data processing method includes acquiring a plurality of second data Da2 corresponding to at least a part of waveform data including first data Da1. The data processing method includes performing the first operation OP1 and the second operation OP2.

The first operation OP1 includes correcting the first processing 71R so that the difference Δ1 between the first data Da1 and the fourth data Da4 obtained by interpolating the plurality of third data Da3 obtained by processing the plurality of second data Da2 by the first processing 71R decreases. The second operation OP2 may include processing the fifth data Da5 by the first processing 71R being corrected to derive the sixth data Da6.

In the data processing method according to the embodiment, the first processing 71R may include processing the plurality of second data Da2 using the learning model 71M including the learning parameters 71P. The learning parameters 71P may be modified so that the difference Δ1 decreases.

The embodiments may include the following Technical proposals:

### Technical Proposal 1

A data processing device, comprising
an acquisitor configured to acquire a plurality of second data corresponding to at least a part of waveform data including a first data; and
a processor,
the processor being configured to perform a first operation and a second operation,
the processor being configured to correct a first processing so that a difference between the first data and fourth data obtained by interpolating a plurality of third data obtained by processing the plurality of second data by the first processing decreases in the first operation, and
the processor being configured to process a plurality of fifth data by the first processing after the correcting to derive a plurality of sixth data in the second operation.

### Technical Proposal 2

The data processing device according to Technical proposal 1, wherein
the processor includes a first processor configured to perform the first processing, and
the first processor is configured to process the plurality of second data using a learning model including a learning parameter.

### Technical Proposal 3

The data processing device according to Technical proposal 2, wherein
the processor includes a second processor, and
the second processor is configured to modify the learning parameters so that the difference decreases.

### Technical Proposal 4

The data processing device according to any one of Technical proposals 1-3, wherein
the processor includes a third processing, and
the third processor is configured to derive the fourth data by interpolating the plurality of third data.

### Technical Proposal 5

The data processing device according to any one of Technical proposals 1-4, wherein
the processor includes a fourth processor, and
the fourth processor is configured to derive the difference between the fourth data and the first data.

### Technical Proposal 6

The data processing device according to any one of Technical proposals 1-5, wherein
the plurality of second data includes periodic data.

### Technical Proposal 7

The data processing device according to any one of Technical proposals 1-5, wherein
the plurality of second data includes information related to a repeatable run out (RRO) of a magnetic recording medium, and
the plurality of fifth data corresponds to the information related to the RRO of the magnetic recording medium.

### Technical Proposal 8

The data processing device according to Technical proposal 7, wherein
a third operation is further performed, and
in the third operation, seventh data is derived by interpolating the plurality of sixth data.

### Technical Proposal 9

The data processing device according to any one of Technical proposals 1-8, wherein
a second number of the plurality of second data is equal to a third number of the plurality of third data.

### Technical Proposal 10

The data processing device according to Technical proposal 9, wherein
the second number is equal to a fifth number of the plurality of fifth data.

### Technical Proposal 11

The data processing device according to any one of Technical proposals 1-8, wherein
a second number of the plurality of second data is smaller than a third number of the plurality of third data.

### Technical Proposal 12

The data processing device according to Technical proposal 11, wherein
the second number is equal to a fifth number of the plurality of fifth data.

### Technical Proposal 13

The data processing device according to any one of Technical proposals 1-12, wherein
an interpolation function for generating the fourth data by interpolating the third data is differentiable.

### Technical Proposal 14

A magnetic recording device, comprising:
the data processing device according to Technical proposal 7 or 8; and
the magnetic recording medium,
the acquisitor being configured to acquire the plurality of second data from the magnetic recording medium.

### Technical Proposal 15

A method for manufacturing a magnetic recording device, comprising:
acquiring a plurality of second data corresponding to at least a part of waveform data including a first data from a magnetic recording medium,
correcting a first processing so that a difference between the first data and fourth data obtained by interpolating a plurality of third data obtained by processing the plurality of second data by the first processing decreases;
processing a plurality of fifth data by the first processing after the correcting to derive a plurality of sixth data.

### Technical Proposal 16

The method according to Technical proposal 15, wherein
the first processing includes processing the plurality of second data using a learning model including a learning parameter, and
the learning parameter is modified so that the difference decreases.

### Technical Proposal 17

The method according to Technical proposal 15 or 16, wherein
the plurality of second data includes information related to a repeatable run out (RRO) of the magnetic recording medium, and
the plurality of sixth data is recorded on the magnetic recording medium.

### Technical Proposal 18

A data processing method, comprising:
acquiring a plurality of second data corresponding to at least a part of waveform data including a first data; and
performing a first operation and a second operation,
in the first operation, correcting a first processing so that a difference between the first data and fourth data obtained by interpolating a plurality of third data obtained by processing the plurality of second data by the first processing decreasing, and
in the second operation, processing a plurality of fifth data by the first processing after the correcting to derive a plurality of sixth data.

### Technical Proposal 19

The data processing method according to Technical proposal 18, wherein
the first processing includes processing the plurality of second data using a learning model including a learning parameter.

### Technical Proposal 20

The data processing method according to Technical proposal 19, wherein
the learning parameter is modified so that the difference decreases.

According to the embodiments, a data processing device, a magnetic recording device, a method for manufacturing a magnetic recording device, and a data processing method can be provided that can improve efficiency.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the data processing devices such as processors, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all data processing devices, all magnetic recording devices, all method for manufacturing magnetic recording devices, and all data processing methods practicable by an appropriate design modification by one skilled in the art based on the data processing devices, the magnetic recording devices, the method for manufacturing magnetic recording devices, and the data processing methods described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A data processing device, comprising
an acquisitor configured to acquire a plurality of second data corresponding to at least a part of waveform data including a first data; and
a processor,
the processor being configured to perform a first operation and a second operation,
the processor being configured to correct a first processing so that a difference between the first data and fourth data obtained by interpolating a plurality of third data obtained by processing the plurality of second data by the first processing decreases in the first operation, and
the processor being configured to process a plurality of fifth data by the first processing after the correcting to derive a plurality of sixth data in the second operation.

2. The data processing device according to claim 1, wherein
the processor includes a first processor configured to perform the first processing, and
the first processor is configured to process the plurality of second data using a learning model including a learning parameter.

3. The data processing device according to claim 2, wherein
the processor includes a second processor, and
the second processor is configured to modify the learning parameters so that the difference decreases.

4. The data processing device according to claim 1, wherein
the processor includes a third processing, and
the third processor is configured to derive the fourth data by interpolating the plurality of third data.

5. The data processing device according to claim 1, wherein
the processor includes a fourth processor, and
the fourth processor is configured to derive the difference between the fourth data and the first data.

6. The data processing device according to claim 1, wherein the plurality of second data includes periodic data.

7. The data processing device according to claim 1, wherein
the plurality of second data includes information related to a repeatable run out (RRO) of a magnetic recording medium, and
the plurality of fifth data corresponds to the information related to the RRO of the magnetic recording medium.

8. The data processing device according to claim 7, wherein
a third operation is further performed, and
in the third operation, seventh data is derived by interpolating the plurality of sixth data.

9. The data processing device according to claim 1, wherein
a second number of the plurality of second data is equal to a third number of the plurality of third data.

10. The data processing device according to claim 9, wherein
the second number is equal to a fifth number of the plurality of fifth data.

11. The data processing device according to claim 1, wherein
a second number of the plurality of second data is smaller than a third number of the plurality of third data.

12. The data processing device according to claim 11, wherein
the second number is equal to a fifth number of the plurality of fifth data.

13. The data processing device according to claim 1, wherein
an interpolation function for generating the fourth data by interpolating the third data is differentiable.

14. A magnetic recording device, comprising:
the data processing device according to claim 7; and
the magnetic recording medium,
the acquisitor being configured to acquire the plurality of second data from the magnetic recording medium.

15. A method for manufacturing a magnetic recording device, comprising:
acquiring a plurality of second data corresponding to at least a part of waveform data including a first data from a magnetic recording medium,
correcting a first processing so that a difference between the first data and fourth data obtained by interpolating a plurality of third data obtained by processing the plurality of second data by the first processing decreases;
processing a plurality of fifth data by the first processing after the correcting to derive a plurality of sixth data.

16. The method according to claim 15, wherein
the first processing includes processing the plurality of second data using a learning model including a learning parameter, and
the learning parameter is modified so that the difference decreases.

17. The method according to claim 15, wherein
the plurality of second data includes information related to a repeatable run out (RRO) of the magnetic recording medium, and
the plurality of sixth data is recorded on the magnetic recording medium.

18. A data processing method, comprising:
acquiring a plurality of second data corresponding to at least a part of waveform data including a first data; and
performing a first operation and a second operation,
in the first operation, correcting a first processing so that a difference between the first data and fourth data obtained by interpolating a plurality of third data obtained by processing the plurality of second data by the first processing decreasing, and
in the second operation, processing a plurality of fifth data by the first processing after the correcting to derive a plurality of sixth data.

19. The data processing method according to claim 18, wherein
the first processing includes processing the plurality of second data using a learning model including a learning parameter.

20. The data processing method according to claim 19, wherein
the learning parameter is modified so that the difference decreases.
